(19) United States
(12) Patent Application Publication
(10) Pub. No.: US 2023/0415675 A1
(43) Pub. Date: Dec. 28, 2023

(54) FIRST ONBOARD ECU, PROGRAM, INFORMATION PROCESSING METHOD, AND ONBOARD SYSTEM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Yuta KINOSHITA, Yokkaichi-shi, Mie (JP)

(21) Appl. No.: 18/247,685

(22) PCT Filed: Sep. 16, 2021
(86) PCT No.: PCT/JP2021/034063

§ 371 Date: Apr. 3, 2023

(30) Foreign Application Priority Data
Oct. 6, 2020 (JP) 2020-169223

(51) Int. Cl. B60R 16/023; B60Q 1/14

(52) U.S. Cl. CPC B60R 16/0231; B60Q 1/1423; B60Q 2300/14

(57) ABSTRACT

A first onboard ECU is communicably connected to an onboard apparatus mounted in a vehicle and a second onboard ECU that outputs information regarding control of the onboard apparatus, and includes a control unit configured to perform processing related to driving of the onboard apparatus, the control unit sequentially obtains a plurality of pieces of information related to control of the onboard apparatus that are output from the second onboard ECU, buffers the sequentially obtained pieces of information in a predetermined storage region, performs processing related to driving of the onboard apparatus based on the information buffered in the predetermined storage region, and the pieces of information buffered in the predetermined storage region include information to be used later than information that is used at the present point in time.

### CROSS-REFERENCE TO RELATED APPLICATIONS

This application is the U.S. national stage of PCT/JP2021/034063 filed on Sep. 16, 2021, which claims priority of Japanese Patent Application No. JP 2020-169223 filed on Oct. 6, 2020, the contents of which are incorporated herein.

### TECHNICAL FIELD

The present disclosure relates to a first onboard ECU, a program, an information processing method, and an onboard system.

### BACKGROUND

There are known vehicle light control apparatuses configured to be able to turn on a plurality of light sources mounted on a vehicle and connected in parallel to a DC-DC converter, at apparently the same time (for example, JP 2020-98718A). The vehicle light control apparatus in JP 2020-98718A includes a memory for storing an output voltage of the DC-DC converter, and is configured to store, in the memory, an output voltage of the DC-DC converter when a light source is on.

There is a problem with the vehicle light control apparatus in JP 2020-98718A in that no consideration has been given to control performed in a configuration where an onboard ECU (Electronic Control Unit) that performs drive control of a vehicle light, and a vehicle control apparatus that derives a luminance value when driving the vehicle light are separate apparatuses.

### SUMMARY

The present disclosure provides a first onboard ECU and the like that can efficiently drive an onboard apparatus connected thereto, based on information output from a second onboard ECU.

A first onboard ECU according to an aspect of the present disclosure is a first onboard ECU that is communicably connected to an onboard apparatus mounted in a vehicle and a second onboard ECU that outputs information regarding control of the onboard apparatus, the first onboard ECU including a control unit configured to perform processing related to driving of the onboard apparatus, the control unit sequentially obtaining a plurality of pieces of information regarding control of the onboard apparatus that are output from the second onboard ECU, buffering, in a predetermined storage region, the sequentially obtained pieces of information, and performing processing related to driving of the onboard apparatus based on the information buffered in the predetermined storage region, and the plurality of pieces of information buffered in the predetermined storage region including information to be used later than information that is used at the present point in time.

### Advantageous Effects

According to an aspect of the present disclosure, it is possible to provide a first onboard ECU and the like that efficiently drive an onboard apparatus connected thereto, based on information output from a second onboard ECU.

### BRIEF DESCRIPTION OF THE DRAWINGS

FIG. 1 is a schematic diagram illustrating an example of a system configuration of an onboard system (an integrated ECU and individual ECUs) according to a first embodiment.

FIG. 2 is a block diagram illustrating an example of an internal configuration of an individual ECU and the like.

FIG. 3 is an explanatory diagram illustrating an example of a flow of processing (a sequence) that is performed by the individual ECU and the integrated ECU.

FIG. 4 is an explanatory diagram illustrating an example of curve information for control and the like.

FIG. 5 is a flowchart illustrating an example of processing that is performed by a control unit of the individual ECU.

FIG. 6 is a flowchart illustrating an example of processing that is performed by a control unit of an individual ECU according to a second embodiment (a processing load of an integrated ECU).

FIG. 7 is an explanatory diagram related to recovery processing (when a duty rate is high) according to a third embodiment (recovery processing).

FIG. 8 is an explanatory diagram related to recovery processing (when the duty rate is low).

FIG. 9 is a flowchart illustrating an example of processing that is performed by the control unit of the individual ECU.

FIG. 10 is a flowchart illustrating an example of recovery processing that is performed by the control unit of the individual ECU.

### DETAILED DESCRIPTION OF PREFERRED EMBODIMENTS

Firstly, embodiments of the present disclosure will be listed and described. At least some of the embodiments described below may be combined as appropriate.

### First Aspect

In accordance with a first aspect, a first onboard ECU according to an aspect of the present disclosure is a first onboard ECU that is communicably connected to an onboard apparatus mounted in a vehicle and a second onboard ECU that outputs information regarding control of the onboard apparatus, the first onboard ECU including a control unit configured to perform processing related to driving of the onboard apparatus, the control unit sequentially obtaining a plurality of pieces of information regarding control of the onboard apparatus that are output from the second onboard ECU, buffering, in a predetermined storage region, the sequentially obtained pieces of information, and performing processing related to driving of the onboard apparatus based on the information buffered in the predetermined storage region, and the plurality of pieces of information buffered in the predetermined storage region including information to be used later than information that is used at the present point in time.

In this aspect, the first onboard ECU buffers the plurality of pieces of information sequentially obtained from the second onboard ECU, in a predetermined storage region accessible by the first onboard ECU, and performs processing related to driving of the onboard apparatus based on the buffered information. The plurality of pieces of information buffered in the predetermined storage region include information to be used later than information that is used at the present point in time, and thus, even when communication between the first onboard ECU and the second onboard ECU is disconnected and transmission of information from the second onboard ECU stops, the first onboard ECU can continue processing related to driving of the onboard apparatus based on the information buffered in the predetermined storage region. Therefore, the first onboard ECU can efficiently drive the onboard apparatus connected thereto, based on information that is output from the second onboard ECU.

### Second Aspect

In a second aspect, the first onboard ECU according to an aspect of the present disclosure, the onboard apparatus is an illumination lamp, the second onboard ECU outputs information regarding control of the illumination lamp generated based on predetermined curve information for control, information that is output from the second onboard ECU includes a duty ratio for controlling a light amount of the illumination lamp, and the control unit performs processing related to driving of the illumination lamp based on the duty ratio obtained from the second onboard ECU.

In this aspect, the second onboard ECU generates and outputs information that includes a duty ratio for performing, for example, fade control of the onboard apparatus that is an illumination lamp, based on curve information for control, and the first onboard ECU performs processing related to driving of the illumination lamp based on the duty ratio. Therefore, when driving the illumination lamp using fade control, processing for generating information that includes a duty ratio and processing for driving the illumination lamp based on the duty ratio can be executed by different onboard ECUs (the second onboard ECU and the first onboard ECU, respectively), thus realizing load distribution between these onboard ECUs (the second onboard ECU and the first onboard ECU), and making it possible to efficiently drive the onboard apparatus.

### Third Aspect

In a third aspect the first onboard ECU according to an aspect of the present disclosure, the control unit changes a capacity of the predetermined storage region that is used for buffering the plurality of pieces of information, in accordance with a state of communication with the second onboard ECU.

In this aspect, the control unit of the first onboard ECU changes the capacity of the predetermined storage region in accordance with the traffic amount of communication of the first onboard ECU (bandwidth usage). The capacity of the storage region is increased as the traffic amount increases and a delay time of communication increases, and the capacity of the storage region is decreased as a delay time decreases. Therefore, even when the traffic amount has increased and exceeded a predetermined threshold and communication between the first onboard ECU and the second onboard ECU is then disconnected due to congestion or the like, the capacity of the predetermined storage region secured for buffering information transmitted from the second onboard ECU is already increased, and the amount of buffered information is also increased. Accordingly, the first onboard ECU can continue processing related to driving of the onboard apparatus for a longer time based on the information buffered in the storage region whose capacity has been increased.

### Fourth Aspect

In a fourth aspect, the first onboard ECU according to an aspect of the present disclosure, the control unit changes the capacity of the predetermined storage region that is used for buffering the plurality of pieces of information, in accordance with a processing load of the second onboard ECU.

In this aspect, the first onboard ECU routinely, periodically, or cyclically obtains information regarding the processing load of the second onboard ECU from the second onboard ECU, and changes the capacity of the predetermined storage region in accordance with the processing load of the second onboard ECU. That is to say, the first onboard ECU increases the capacity of the storage region as the processing load of the second onboard ECU increases, and decreases the capacity of the storage region as the processing load decreases. Therefore, even when the processing load of the second onboard ECU increases and exceeds a predetermined threshold, and the processing responsiveness of the second onboard ECU then decreases significantly and communication between the first onboard ECU and the second onboard ECU is disconnected, the capacity of the predetermined storage region secured for buffering information transmitted from the second onboard ECU is already increased. Accordingly, the amount of information buffered in the predetermined storage region is also increased. Therefore, the first onboard ECU can continue processing related to driving of the onboard apparatus for a longer time based on the information buffered in the storage region whose capacity has been increased.

### Fifth Aspect

In a fifth aspect, the first onboard ECU according to an aspect of the present disclosure, when all of the pieces of information buffered in the predetermined storage region have been used as a result of communication with the second onboard ECU being disconnected, the control unit derives an estimated value based on a plurality of previously used pieces of information, and performs processing related to driving of the onboard apparatus using the estimated value.

In this aspect, when all of the pieces of buffered information have been used as a result of communication with the second onboard ECU being disconnected, the control unit of the first onboard ECU derives an estimated value based on a plurality of pieces of previously used information, using various methods such as linear approximation that uses the least-squares method, a logarithmic approximation curve, a polynomial approximation curve, a power approximation curve, or an exponential approximation curve. The first onboard ECU performs processing related to driving of the onboard apparatus using the derived estimated value, and thus, even after communication between the first onboard ECU and the second onboard ECU has been disconnected, the first onboard ECU can further continue the processing related to driving of the onboard apparatus.

### Sixth Aspect

In a sixth aspect, the first onboard ECU according to an aspect of the present disclosure, information that is output from the second onboard ECU includes a duty ratio for controlling a light amount of the onboard apparatus that is an illumination lamp, the control unit performs, when disconnected communication with the second onboard ECU is resumed, recovery processing that is based on information obtained from the second onboard ECU after the resumption of communication, and a time period required for recovery processing when the duty ratio is higher than or equal to a predetermined threshold is shorter than a time period required for recovery processing when the duty ratio is lower than the predetermined threshold.

In this aspect, when disconnected communication with the second onboard ECU is resumed, the control unit of the first onboard ECU performs recovery processing that is based on information obtained from the second onboard ECU after the resumption of communication. The information includes a duty ratio for performing fade control of the onboard apparatus that is an illumination lamp, and the control unit of the first onboard ECU performs recovery processing based on a required time period corresponding to the duty ratio. That is to say, a time period required for recovery processing when the duty ratio is higher than or equal to a predetermined threshold is set to a shorter time period than a time period required for recovery processing when the duty ratio is lower than the predetermined threshold, and, thereby, communication can be recovered roughly when the duty ratio is higher than or equal to the predetermined threshold, and can be recovered smoothly when the duty ratio is lower than the predetermined threshold. In an illumination lamp whose light amount is controlled based on a duty ratio (duty ratio=pulse width/cycle) of a semiconductor switch such as a FET, the light amount increases (becomes brighter) as the duty ratio increases, and the light amount decreases (becomes darker) as the duty ratio decreases. At this time, when the duty ratio is lower (darker), a passenger of the vehicle is likely to feel that something is amiss if the duty ratio changes rapidly, but it is possible to suppress the sensation that something is amiss by setting the time period required for recovery processing when the duty ratio is lower than the predetermined threshold to a relatively longer time period. In addition, when the duty ratio is higher (brighter), a passenger of the vehicle is less likely to feel that something is amiss even if the duty rate is changed rapidly, and thus, by setting, to a shorter time period, the time period required for recovery processing when the duty ratio is higher than or equal to the predetermined threshold, it is possible to recover control performed by the second onboard ECU that has resumed communication, at an early stage.

### Seventh Aspect

In a seventh aspect, the first onboard ECU according to an aspect of the present disclosure, when performing the recovery processing, the control unit derives a recovery processing duty ratio using a derived estimated value, a duty ratio included in information obtained after communication with the second onboard ECU has been resumed, and the time period required for recovery processing, and performs processing related to driving of the onboard apparatus based on the derived recovery processing duty ratio.

In this aspect, during the period of (the time period required for) recovery processing, the control unit of the first onboard ECU performs processing related to driving of the onboard apparatus based on a recovery processing duty ratio derived using a derived estimated value, a duty ratio included in information obtained after communication with the second onboard ECU has been resumed, and the time period required for recovery processing. Therefore, a plurality of recovery processing duty ratios that realize a suitable change rate corresponding to the time period required for recovery processing are derived for the difference (A duty ratio) between a duty ratio that is based on an estimated value derived while communication with the second onboard ECU is disconnected, and the duty ratio obtained after communication has been resumed, and recovery processing can be smoothly performed by sequentially using these recovery processing duty ratios.

### Eighth Aspect

In an eighth aspect, a program according to an aspect of the present disclosure causes a computer that is communicably connected to an onboard apparatus mounted in a vehicle and a second onboard ECU that outputs information regarding control of the onboard apparatus, to perform processing for sequentially obtaining a plurality of pieces of information regarding control of the onboard apparatus that are output from the second onboard ECU, buffering, in a predetermined storage region, the sequentially obtained pieces of information, and performing processing related to driving of the onboard apparatus based on the information buffered in the predetermined storage region, and the plurality of pieces of information buffered in the predetermined storage region include information to be used later than information that is used at the present point in time.

In this aspect, it is possible to cause a computer to function as the first onboard ECU that efficiently drives the onboard apparatus connected to the first onboard ECU, based on information output from the second onboard ECU.

### Ninth Aspect

In a ninth aspect, an information processing method according to an aspect of the present disclosure causes a computer that is communicably connected to an onboard apparatus mounted in a vehicle and a second onboard ECU that outputs information regarding control of the onboard apparatus, to perform processing for sequentially obtaining a plurality of pieces of information regarding control of the onboard apparatus that are output from the second onboard ECU, buffering, in a predetermined storage region, the sequentially obtained pieces of information, and performing processing related to driving of the onboard apparatus based on the information buffered in the predetermined storage region, and the plurality of pieces of information buffered in the predetermined storage region include information to be used later than information that is used at the present point in time.

In this aspect, it is possible to provide an information processing method in which a computer is caused to function as a first onboard ECU that efficiently drives the onboard apparatus connected thereto, based on information output from the second onboard ECU.

### Tenth Aspect

In a tenth aspect, an onboard system according to an aspect of the present disclosure is an onboard system that includes a first onboard ECU that is directly connected to an onboard apparatus and a second onboard ECU that is communicably connected to the first onboard ECU, the second onboard ECU generating a plurality of control signals for controlling the onboard apparatus based on predetermined curve information for control, and sequentially outputting the generated control signals to the first onboard ECU, the first onboard ECU sequentially obtaining the control signals output from the second onboard ECU, buffering, in a predetermined storage region, the sequentially obtained control signals, generating a drive signal for driving the onboard apparatus based on information buffered in the predetermined storage region, and sequentially outputting the generated drive signals to the onboard apparatus, and the plurality of control signals buffered in the predetermined storage region include a control signal to be used later than a control signal that is used at the present point in time.

In this aspect, it is possible to provide an onboard system in which, even when communication between the first onboard ECU and the second onboard ECU is disconnected, and transmission of information from the second onboard ECU stops, the first onboard ECU continues processing related to driving of the onboard apparatus based on information buffered in the predetermined storage region.

The present disclosure will be described in detail with reference to the drawings illustrating embodiments of the present disclosure. An onboard system S according to an embodiment of the present disclosure will be described below with reference to the drawings. Note that the present disclosure is not limited to these examples, but is defined by the claims and intended to include all modifications within the meaning and scope equivalent to the claims.

### First Embodiment

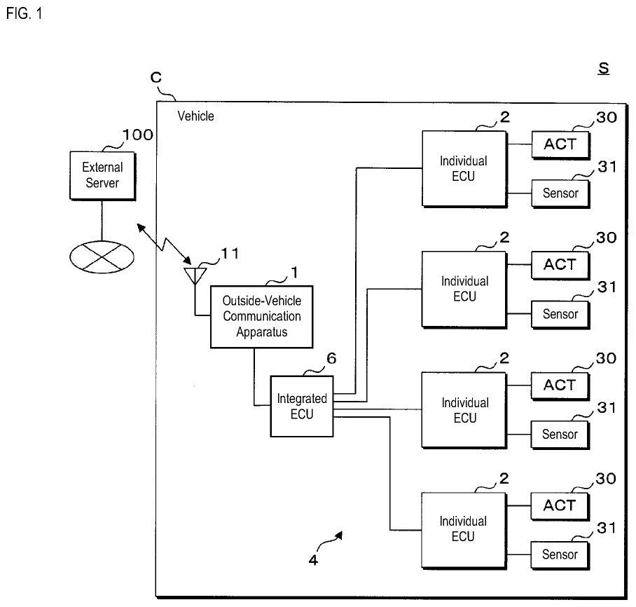

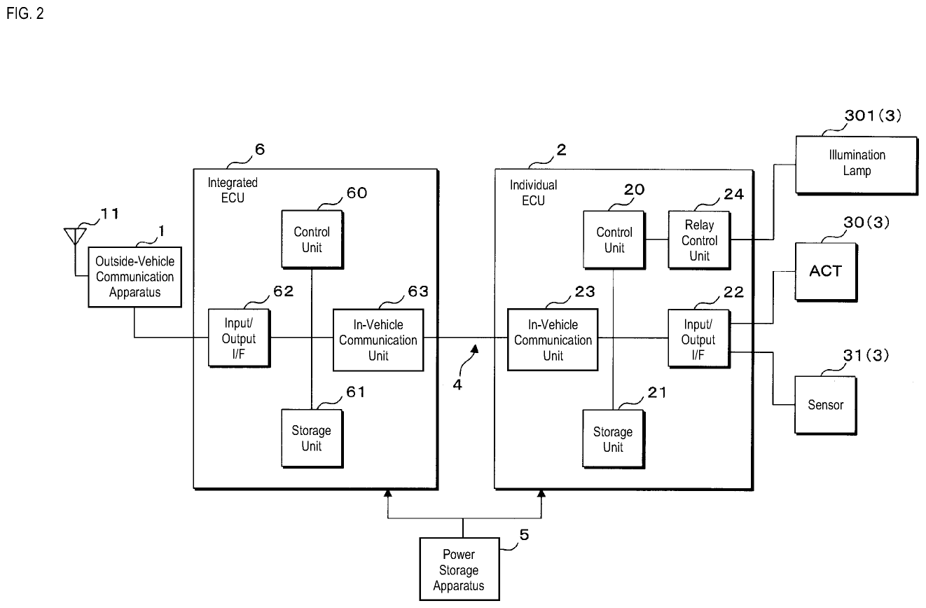

An embodiment will be described below with reference to the drawings. FIG. 1 is a schematic diagram illustrating an example of a system configuration of the onboard system S (an integrated ECU 6 and individual ECUs 2) according to a first embodiment. FIG. 2 is a block diagram illustrating an example of an internal configuration of an individual ECU 2 and the like. The onboard system S includes the integrated ECU 6 mounted in a vehicle C, a plurality of individual ECUs 2, and onboard apparatuses 3 directly connected to the individual ECUs 2. Each individual ECU 2 corresponds to a first onboard ECU, and the integrated ECU 6 corresponds to a second onboard ECU.

The individual ECUs 2 are disposed in different areas in the vehicle C, and are each connected directly to an actuator 30 of an illumination lamp 301 or the like, and an onboard apparatus such as a sensor, using wire harnesses such as serial cables (direct lines). Each individual ECU 2 obtains (receives) a signal (input signal) output from a sensor, and transmits a request signal generated based on the obtained input signal to the integrated ECU 6, for example. The individual ECU 2 performs drive control of the actuator 30 of the illumination lamp 301 or the like directly connected to the individual ECU 2, based on a control signal transmitted from the integrated ECU 6. The individual ECU 2 may be a relay control ECU functioning as an onboard relay apparatus such as a gateway or an Ethernet switch for relaying communication between a plurality onboard apparatuses 3 connected to the individual ECU 2 or communication between the onboard apparatus 3 and the integrated ECU 6. The individual ECU 2 may be a PLB (Power Lan Box) that, in addition to relaying communications, functions as a power distribution apparatus that distributes and relays power output from a power storage apparatus 5 and supplies power to the onboard apparatus 3 connected to the individual ECU 2.

The integrated ECU 6 generates and outputs a control signal for each onboard apparatus 3 based on data from the onboard apparatus 3 relayed via the individual ECU 2, and is a central control apparatus such as a vehicle computer. The integrated ECU 6 generates, based on information or data such as a request signal output (transmitted) from the individual ECU 2, a control signal for controlling the actuator 30 that is the target of the request signal, and outputs (transmits) the generated control signal to the individual ECU 2. A plurality of integrated ECUs 2 are connected to the integrated ECU 6 via an onboard network 4, and request signals respectively transmitted from these integrated ECUs 2 may cause contention for control of the actuator 30. In order to address this, a configuration may be adopted in which the integrated ECU 6 determines a priority order of controls in contention due to these request signals, and performs processing based on the priority order, thereby resolving contention for control of the actuator 30.

Examples of the onboard apparatus 3 include various sensors 31 including a LiDAR (Light Detection and Ranging) sensor, a light sensor, a CMOS camera, and an infrared sensor, switches including a door SW (switch) and a lamp SW, and the actuator 30 of a lamp, a door opening/closing apparatus, a motor apparatus, and the like. The lamp may be the illumination lamp 301 that emits light using fade control for changing a light amount stepwise.

An external server 100 is a computer such as a server connected to an outside-vehicle network such as the Internet or a public network, and is provided with a storage unit constituted by a RAM (Random Access Memory), a ROM (Read Only Memory), a hard disk, or the like. The integrated ECU 6 may be communicably connected to an outside-vehicle communication apparatus 1, communicate, via the outside-vehicle communication apparatus 1, with the external server 100 connected (to the onboard system 5) via the outside-vehicle network, and relay communication between the external server 100 and the individual ECU 2 or the onboard apparatus 3 mounted in the vehicle C.

The outside-vehicle communication apparatus 1 includes an outside-vehicle communication unit (not shown) and an I/O interface (not shown) for communicating with the integrated ECU 6. The outside-vehicle communication unit is a communication apparatus for performing wireless communication using a mobile communication protocol such as 4G, LTE (Long-Term Evolution, registered trademark), 5G, or WiFi, and transmits/receives data to/from the external server 100 via an antenna 11 connected to the outside-vehicle communication unit. Communication between the outside-vehicle communication apparatus 1 and the external server 100 is performed via an external network N such as a public network or the Internet. The I/O interface is a communication interface for performing, for example, serial communication with the integrated ECU 6. The outside-vehicle communication apparatus 1 and the integrated ECU 6 communicate with each other via the I/O interface and a wire harness such as a serial cable connected to the I/O interface. In the present embodiment, the outside-vehicle communication apparatus 1 is a separate apparatus from the integrated ECU 6 and is communicatively connected to the integrated ECU 6 via the I/O interface and the like, but there is no limitation thereto. The outside-vehicle communication apparatus 1 may be incorporated in the integrated ECU 6 as a constituent element of the integrated ECU 6.

The integrated ECU 6 includes a control unit 60, a storage unit 61, an input/output I/F 62, and an in-vehicle communication unit 63. The control unit 60 is constituted by a CPU (Central Processing Unit), an MPU (Micro Processing Unit), or the like and executes various types of control processing, computation processing, and the like by reading out and executing a control program and data stored in advance in the storage unit 61. The control unit 60 is not limited only to a software processing unit such as a CPU that performs software processing, and may include a hardware processing unit that performs various types of control processing, computation processing, and the like through hardware processing, such as an FPGA, an ASIC, or an SOC.

The storage unit 61 is constituted by a volatile memory element such as a RAM (Random Access Memory) or a non-volatile memory element such as a ROM (Read Only Memory), an EEPROM (Electrically Erasable Programmable ROM), or a flash memory, and stores, in advance, a control program and data that is referenced when processing is executed. The control program stored in the storage unit 61 may be a control program read out from a storage medium readable by the integrated ECU 6. Also, the control program may be a control program downloaded from an external computer (not shown) connected to a communication network (not shown) and stored in the storage unit 61. The storage unit 61 of the integrated ECU 6 stores curve information for control (fade curve information) for controlling driving (light emission) of the illumination lamp 301. Although a detailed description will be given later, the curve information for control (fade curve information) uses initiation of light emission as a base point, and includes information regarding luminance values at time points in a predetermined cycle, in order to change the light amount (luminance value) of the illumination lamp 301 in a stepwise manner (fade control).

Similarly to the I/O interface of the outside-vehicle communication apparatus 1, the I/O interface 62 is a communication interface for performing serial communication, for example. The integrated ECU 6 is communicably connected to the outside-vehicle communication apparatus 1 via the input/output I/F 62 and a wire harness such as a serial cable.

The in-vehicle communication unit 63 is an I/O interface that uses a CAN (Controller Area Network) or Ethernet (registered trademark) communication protocol, for example, and the control unit 60 mutually communicates with the individual ECUs 2 connected to the onboard network 4, via the in-vehicle communication unit 63.

Similarly to the integrated ECU 6, each individual ECU 2 includes a control unit 20, a storage unit 21, an input/output I/F 22, an in-vehicle communication unit 23, and a relay control unit 24, and is connected to the illumination lamp 301 via the relay control unit 24. That is to say, the individual ECU 2 and the illumination lamp 301 are directly connected to each other. The control unit 20, the storage unit 21, the input/output I/F 22, and the in-vehicle communication unit 23 of the individual ECU 2 may have the same configurations as those of the integrated ECU 6.

The input/output I/F 22 of the individual ECU 2 is directly connected to the onboard apparatus 3 such as the actuator 30 or a sensor 31 using a wire harness (direct line) such as a serial cable.

A control signal output from the integrated ECU 6 is buffered (stored) in the storage unit 21 of the individual ECU 2. That is to say, a partial region of the storage unit 21 of the individual ECU 2 is secured (allocated) in advance as a predetermined storage region (buffer region) for buffering a control signal output from the integrated ECU 6. The capacity of the predetermined storage region (buffer region) is determined in advance, and the control unit 20 of the individual ECU 2 changes the capacity of the buffer region in accordance with the state of communication with the integrated ECU 6.

The relay control unit 24 of the individual ECU 2 includes a semiconductor switch such as a FET (Field Effect Transistor) or a mechanical relay, and is connected to the actuator 30 of the illumination lamp 301 or the like via a power line. The relay control unit 24 supplies power and cuts off the supply of power to the actuator 30 of the illumination lamp 301 or the like. The relay control unit 24 controls driving of the actuator 30 of the illumination lamp 301 or the like connected to the individual ECU 2 using the power supply line, by switching the semiconductor switch on or off based on a drive signal (gate signal) output from the control unit 20. If the relay control unit 24 is constituted by a FET, the duty ratio of a gate voltage that is applied to the gate terminal of the FET corresponds to the light amount (luminance value) of the illumination lamp 301.

Using the relay control unit 24 that includes the semiconductor switch to control driving of the actuator 30 of the illumination lamp 301 or the like is an example, and there is no limitation thereto. The relay control unit 24 may be an actuator-30 drive control unit for controlling driving of the actuator 30 connected to the individual ECU 2. That is to say, the actuator-30 drive control unit for controlling driving of the actuator 30 may output a control signal to the actuator 30 connected to the individual ECU 2 via the in-vehicle communication unit 23 or a communication unit that includes the I/O interface 22, and control driving of the actuator 30. The actuator-30 drive control unit may be a functional unit that functions in response to the control unit 20 executing a control program.

By executing a program stored in the storage unit 21 of the individual ECU 2, the individual ECU 2 obtains a signal (input signal) output from the onboard apparatus 3 such as the sensor 31 connected to the individual ECU 2, and outputs data (request signal) generated based on the signal (input signal) to the integrated ECU 6. The individual ECU 2 obtains data (a control signal) output from the integrated ECU 6, and outputs a signal (drive signal) generated based on the data (control signal), to the onboard apparatus 3 such as the actuator 30 connected to the individual ECU 2, or performs on/off control of the relay control unit 24 connected to the actuator 30, thereby performing drive control of the actuator 30. The control signal output from the integrated ECU 6 is temporarily buffered in the predetermined storage region (buffer region), read out by the control unit 20 of the individual ECU 2, and is then converted into a drive signal. Therefore, even when communication between the integrated ECU 6 and the individual ECU 2 is temporarily disconnected, the individual ECU 2 can continue to generate a drive signal and to drive the actuator 30 based on a drive signal, based on the control signal buffered in the predetermined storage region (buffer region).

The integrated ECU 6 and the plurality of individual ECUs 2 configured as described above are communicably connected to each other in a star network topology as illustrated in FIG. 1, for example. Furthermore, adjacent individual ECUs 2 may be connected to each other so as to form a loop network topology, thus achieving redundancy and enabling interactive communication.

The integrated ECU 6 and the plurality of individual ECUs 2 are connected to the power storage apparatus 5 that is a lead battery or the like, by power lines, and are supplied with power from the power storage apparatus 5. The actuator 30 of the illumination lamp 301 or the like directly connected to each individual ECU 2 is supplied with power from the power storage apparatus 5 via the individual ECU 2.

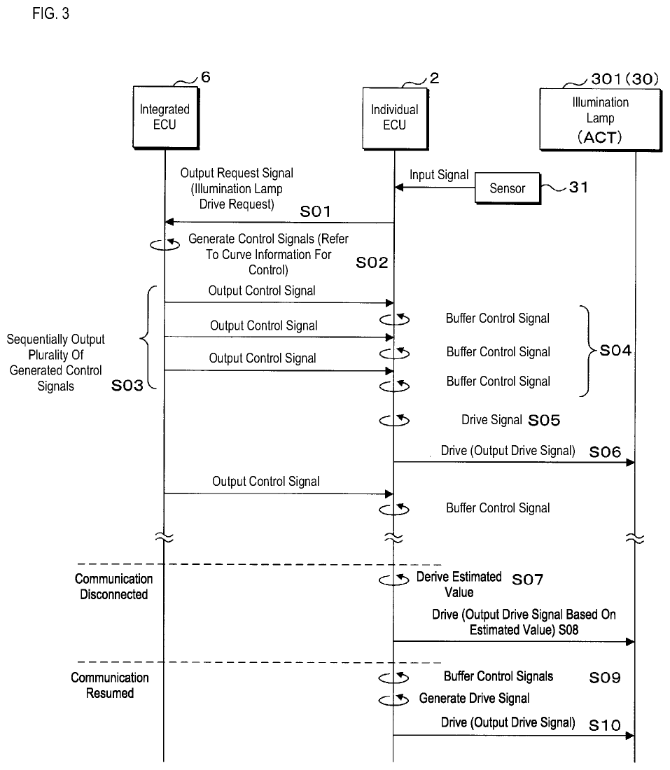

FIG. 3 is an explanatory diagram illustrating an example of a flow of processing (a sequence) that is performed by the individual ECU 2 and the integrated ECU 6. The flow of processing performed when the illumination lamp 301 is driven (emits light) through cooperative processing performed by the integrated ECU 6 and an individual ECU 2 directly connected to the sensor 31 such as a lamp sensor and the illumination lamp 301, for example, using, as a trigger, the result of detection obtained by the sensor 31 will be described with reference to the sequence diagram.

The individual ECU 2 generates a request signal related to driving of the illumination lamp 301 based on an input signal received from the sensor 31, and outputs (transmits) the generated request signal to the integrated ECU 6 (step S01).

The integrated ECU 6 obtains (receives) the request signal output (transmitted) from the individual ECU 2, refers to the curve information for control (fade curve information) based on the request signal, and generates a plurality of control signals (step S02). Each of the control signals includes a duty ratio for controlling the light amount (luminance value) of the illumination lamp 301, and data related to time information (a time point of a cycle) for using the duty ratio.

The integrated ECU 6 sequentially outputs (transmits) the generated control signals to the individual ECU 2 (step S03). The integrated ECU 6 generates a plurality of control signals to be used from the start to the end of control of the illumination lamp 301, and continuously performs processing for sequentially outputting the generated control signals to the individual ECU 2 in a predetermined cycle (control signal transmission cycle).

The individual ECU 2 buffers (stores) the control signals sequentially obtained (received) from the integrated ECU 6, to the predetermined storage region (buffer region) of the storage unit 21 of the individual ECU 2 or the like (step S04). The buffer region may be obtained by securing (allocating) a specific address region in the storage unit 21 in order to buffer control signals obtained from the integrated ECU 6, and has a predetermined capacity (storage capacity).

The individual ECU 2 refers to the control signals buffered (stored) in the predetermined storage region (buffer region), and generates a drive signal for the illumination lamp 301 in a predetermined cycle (drive signal generation cycle) based on the control signals (step S05). The individual ECU 2 drives the illumination lamp 301 based on the generated drive signal (step S06). The drive signal generated by the individual ECU 2 includes a gate voltage and a duty ratio for performing on/off control of the relay control unit 24 (an FET or the like) connected to the illumination lamp 301 in order to control the light amount of the illumination lamp 301. The duty ratio corresponds to the luminance value of the illumination lamp 301. The individual ECU 2 applies the gate voltage to a gate terminal of the relay control unit 24 constituted by an FET or the like, based on the duty ratio. Accordingly, the illumination lamp 301 is driven (emits light).

The cycle (drive signal generation cycle) in which a drive signal for the illumination lamp 301 is generated and output to the relay control unit 24 may be longer than the cycle (control signal transmission cycle) in which the integrated ECU 6 transmits control signals to the individual ECU 2. As a result of the drive signal generation cycle and the control signal transmission cycle being different in this manner, the individual ECU 2 can buffer (store) control signals to be used later than the present point in time to the predetermined storage region (buffer region) in order to continue to drive the illumination lamp 301. The capacity with which data can be stored in the predetermined storage region (buffer region) is determined in advance, and the individual ECU 2 can buffer (store), in the buffer region, control signals sequentially obtained (received) from the integrated ECU 6 until (the upper limit value of) the capacity is reached.

The individual ECU 2 may periodically obtain the traffic amount of the onboard network 4 (bandwidth usage), and change the capacity of the buffer region in accordance with the traffic amount. That is to say, the individual ECU 2 may increase the capacity of the buffer region when the traffic amount is larger than or equal to a predetermined value. The individual ECU 2 may decrease the capacity of the buffer region when the traffic amount is smaller than the predetermined value.

Once all of the control signals buffered (stored) in the predetermined storage region (buffer region) have been used, the individual ECU 2 derives at least one estimated value based on previously used control signals (step S07). When the traffic amount of the onboard network 4 increases, resulting in congestion, for example, and communication between the individual ECU 2 and the integrated ECU 6 is disconnected, transmission of control signals from the integrated ECU 6 is also disconnected. When transmission of control signals is disconnected, buffering (storing) control signals in the predetermined storage region (buffer region) also stops. In order to address this, control signals to be used later than a control signal that is used at the present point in time are also buffered (stored) in the buffer region, and thus, even when communication with the integrated ECU 6 is disconnected, the individual ECU 2 can continue to drive the illumination lamp 301 using the control signals to be used later. In addition to this, when communication between the individual ECU 2 and the integrated ECU 6 continues to be further disconnected, and, after all of the control signals buffered (stored) in the buffer region have been used, the individual ECU 2 derives at least one estimated value based on the previously used control signals. The estimated value may be derived based on a duty ratio included in a previously used control signal, or a duty ratio included in a drive signal generated based on the control signal. The individual ECU 2 derives at least one estimated value based on the last used control signal and a plurality of past consecutive control signals used immediately before the lastly used control signal. Specifically, the individual ECU 2 derives a duty ratio (estimated duty ratio) that is an estimated value, based on five consecutive duty ratios used in the past, for example, including the last used control signal (duty ratio).

The individual ECU 2 continues to drive the illumination lamp 301 using the at least one derived estimated value (step S08). The individual ECU 2 generates a drive signal based on the derived estimated value, and continues to drive the illumination lamp 301 using the drive signal.

When communication between the individual ECU 2 and the integrated ECU 6 is resumed, the individual ECU 2 resumes obtaining control signals from the integrated ECU 6 and buffering (storing) of the obtained control signals in the predetermined storage region (buffer region) (step S09). The individual ECU 2 refers to the control signals buffered (stored) in the predetermined storage region (buffer region), and resumes deriving a drive signal for the illumination lamp 301 based on the control signals and driving the illumination lamp 301 (step S10). In response to communication between the individual ECU 2 and the integrated ECU 6 being disconnected, the individual ECU 2 may derive an estimated value, and output (transmit) processing log information indicating that the illumination lamp 301 has been driven based on the derived estimated value, to the external server 100 via the outside-vehicle communication apparatus 1 connected to the integrated ECU 6. By outputting (transmitting) information indicating an event that occurred in the vehicle C to the external server 100 in this manner, it is possible to improve the traceability of the event that occurred in the vehicle C.

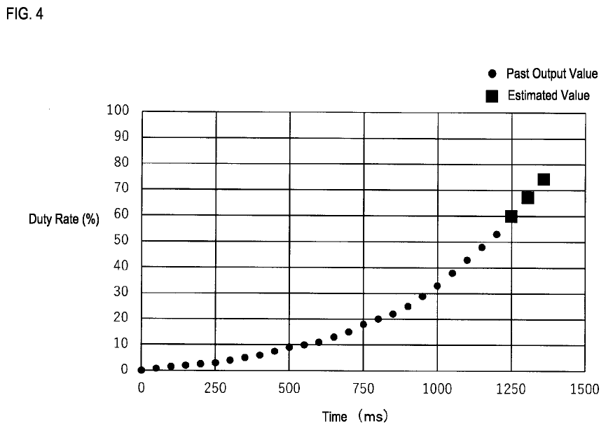

FIG. 4 is an explanatory diagram illustrating an example of the curve information for control. In the illustrated figure of the present embodiment, the horizontal axis indicates time points (lapsed time) in a predetermined cycle in which initiation of light emission serves as a base point, and the vertical axis indicates duty ratios each corresponding to a light amount (luminance value) of the illumination lamp 301.

The luminance values (duty ratios) indicated by the illustrated graph includes luminance values related to the curve information for control stored in the storage unit 61 of the integrated ECU 6, and luminance values (duty ratios) that are derived by the individual ECU 2 as estimated values. It goes without saying that the light amount (luminance value) of the illumination lamp 301 is increased by increasing the duty ratio.

The storage unit 61 of the integrated ECU 6 stores curve information for control (fade curve information) that is used to control driving (light emission) of the illumination lamp 301. The curve information for control (fade curve information) uses initiation of light emission as a base point, and includes information regarding luminance values at respective time points in the predetermined cycle in order to change the light amount (luminance value) of the illumination lamp 301 in a stepwise manner. In the present embodiment, the curve information for control is shown in a graph format, but there is no limitation thereto, and the curve information for control may be stored in a table format in the storage unit 61 of the integrated ECU 6.

In the illustrated figure of the present embodiment, points indicated by black dots represent some of the luminance values (duty ratios) included in the curve information for control (fade curve information) stored in the storage unit 61 of the integrated ECU 6. The black dots form a curve, and, by increasing the duty ratio at time points (lapsed times) in a stepwise manner in the predetermined cycle in which the initiation of light emission is used as a base point, it is possible to gradually increase the luminance value of the illumination lamp 301, and perform gradational light adjustment.

In the illustrated figure of the present embodiment, points indicated by black squares represent duty ratios estimated by the individual ECU 2 (estimated values). As described above, the individual ECU 2 derives a duty ratio (estimated duty ratio) that is an estimated value, for example, based on five consecutive duty ratios used in the past, including the last used control signal (duty ratio). The individual ECU 2 may generate an approximation formula based on these five consecutive duty ratios used in the past, for example, and derive an estimated value using the approximation formula. The individual ECU 2 may use various methods such as linear approximation that uses the least-squares method, a logarithmic approximation curve, a polynomial approximation curve, a power approximation curve, or an exponential approximation curve in order to generate the approximation formula.

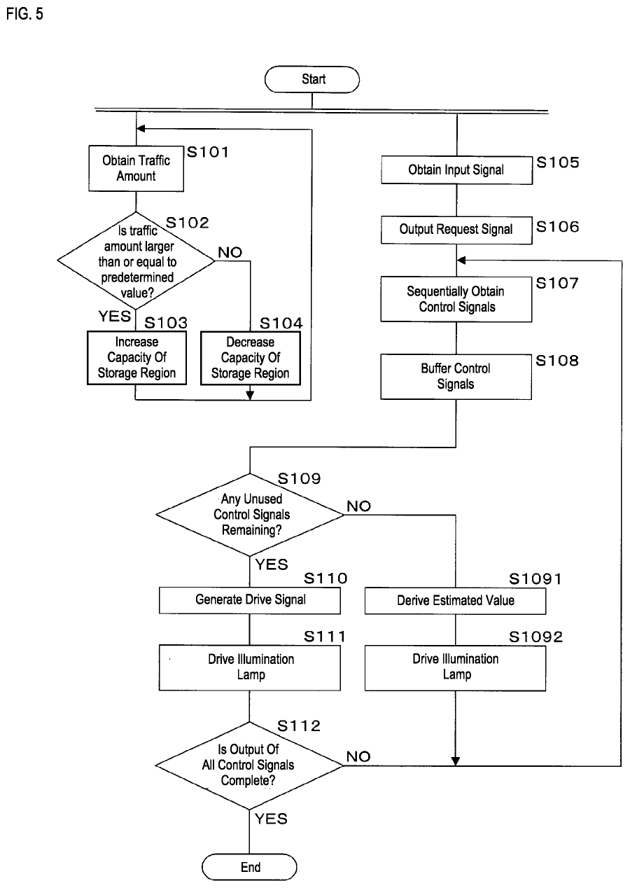

FIG. 5 is a flowchart illustrating an example of processing that is performed by the control unit 20 of the individual ECU 2. The control unit 20 of the individual ECU 2 routinely executes the following processing when the vehicle C is in an activated state (an ignition switch is on), for example.

The control unit 20 of the individual ECU 2 obtains the traffic amount of the onboard network 4 (step S101). The control unit 20 of the individual ECU 2 obtains the communication amount per unit time, namely the traffic amount of the onboard network 4, or the bandwidth usage, by obtaining carrier-sense information regarding the onboard network 4 via the in-vehicle communication unit 23, for example.

The control unit 20 of the individual ECU 2 determines whether or not the traffic amount is larger than or equal to a predetermined value (step S102). The storage unit 21 of the individual ECU 2 stores information regarding the predetermined value as the bandwidth usage of 50%, for example. The control unit of the individual ECU 2 determines whether or not the traffic amount of the onboard network 4 connected to the integrated ECU 6 and the individual ECU 2 is larger than or equal to the predetermined value, based on the predetermined value stored in the storage unit 21.

If the traffic amount is larger than or equal to the predetermined value (step S102: YES), the control unit 20 of the individual ECU 2 increases the capacity of the predetermined storage region (step S103). If the traffic amount is larger than or equal to the predetermined value, the onboard network 4 is expected to become congested, and thus the control unit 20 of the individual ECU 2 increases the capacity of the predetermined storage region (buffer region), obtains control information from the integrated ECU 6, and increases the amount of control information to be buffered.

If the traffic amount is smaller than the predetermined value (step S102: NO), the control unit 20 of the individual ECU 2 decreases the capacity of the predetermined storage region (step S104). If the traffic amount is smaller than the predetermined value, the control unit 20 of the individual ECU 2 can secure a storage region to be used for other processing by the individual ECU 2, by releasing a portion of the occupied buffer region so as to decrease the capacity.

After executing the processing of step S103 or S104, the control unit 20 of the individual ECU 2 performs loop processing in order to execute the processing of step S101 again. By performing, in this manner, the processing of steps S101 to S104 in a process in parallel with a different process of performing other processing, it is possible to continue to change (increase/decrease) the capacity of the predetermined storage region in accordance with the traffic amount (the bandwidth usage) of the onboard network 4, and, even when the onboard network 4 is congested, it is possible to deal with such congestion.

The control unit 20 of the individual ECU 2 obtains an input signal from the sensor 31 (step S105). The control unit 20 of the individual ECU 2 obtains an input signal from the sensor 31 such as a light sensor directly connected to the individual ECU 2.

The control unit 20 of the individual ECU 2 outputs a request signal to the integrated ECU 6 (step S106). The control unit 20 of the individual ECU 2 generates, based on the input signal obtained from the sensor 31, a request signal requesting the generation and the like of a control signal related to the actuator 30 of the illumination lamp 301 or the like that is the target of the input signal, and outputs the generated request signal to the integrated ECU 6. The integrated ECU 6 refers to the curve information for control (fade curve information) stored in the storage unit 61 thereof, based on the request signal from the individual ECU 2, generates a plurality of control signals, and sequentially transmits the control signals to the individual ECU 2.

The control unit 20 of the individual ECU 2 sequentially obtains a plurality of control signals transmitted from the integrated ECU 6 (step S107). The control unit 20 of the individual ECU 2 buffers the obtained control signals in the predetermined storage region (step S108). Processing for obtaining control signals transmitted from the integrated ECU 6, and buffering the obtained control signals is performed continuously by the control unit 20 of the individual ECU 2, even when executing subsequent processing. That is to say, the control unit 20 of the individual ECU 2 executes subsequent processing while continuing to communicate with (obtain control signals from) the integrated ECU 6. The control unit 20 of the individual ECU 2 may obtain control signals from the integrated ECU 6 and buffer the obtained control signals, in a process executed in parallel with a different process of executing the subsequent processing.

The control unit 20 of the individual ECU 2 determines whether or not there is an unused control signal in the predetermined storage region (step S109). If there is an unused control signal (step S109: YES), the control unit 20 of the individual ECU 2 generates a drive signal for the illumination lamp 301 based on control signals buffered in the predetermined storage region (step S110). In order to generate a drive signal, the control unit 20 of the individual ECU 2 sets a flag for a used control signal, for example, and adds information indicating that the control signal has been used. By setting the flag, a plurality of control signals buffered (stored) in the predetermined storage region (buffer region) can be managed such that used control signals and unused control signals are separated from each other in order to generate a drive signal.

Not only a control signal that is used at the present point in time but also control signals to be used at a later time are buffered (stored) in the predetermined storage region (buffer region). These control signals are signals that are used in a continuous manner in order to perform drive control of the illumination lamp 301, and each of the control signals includes, for example, a serial number or temporal information such as time information indicating a use time point. In addition to this, by setting a flag or the like for a control signal used for generating a drive signal, it is possible to specify the last used control signal, and efficiently specify the next control signal (second in order) to be used immediately after the last used control signal.

The control unit 20 of the individual ECU 2 drives the illumination lamp 301 based on a generated drive signal (step S111). The illumination lamp 301 emits light based on a luminance value corresponding to the drive signal (duty ratio). The drive signal is generated based on the curve information for control (fade curve information) stored in the storage unit 61 of the integrated ECU 6, and thus the illumination lamp 301 emits light while changing the light amount thereof in a stepwise manner based on information defined by the curve information for control (fade curve information).

If there are no unused control signals (step S109: NO), the control unit 20 of the individual ECU 2 derives an estimated value based on control signals used in the past (step S1091). Processing for obtaining a plurality of control signals transmitted from the integrated ECU 6 and processing for buffering obtained control signals, which are performed by the control unit 20 of the individual ECU 2, are performed under the assumption that communication between the individual ECU 2 and the integrated ECU 6 is normal. However, in the onboard network 4 that communicably connects the individual ECU 2 and the integrated ECU 6, communication between the individual ECU 2 and the integrated ECU 6 can be disconnected, for example, as a result of occurrence of congestion and an increase in the traffic amount. Even in this case, control signals to be used later than the control signal that is used at the present point in time are also buffered (stored) in the buffer region, and thus, even when communication with the integrated ECU 6 is disconnected, the individual ECU 2 can continue to drive the illumination lamp 301 using the control signals to be used later.

However, once all of the buffered control signals have been used, no unused control signal remains in the buffer region. In view of this, the control unit 20 of the individual ECU 2 generates an approximation formula, for example, based on a plurality of previously used control signals (duty ratios), up to a predetermined number of control signals from the last used control signal (duty ratio), and derives an estimated value (estimated duty ratio) using the approximation formula. The control unit 20 of the individual ECU 2 may generate an approximation formula, for example, using various methods such as linear approximation that uses the least-squares method, a logarithmic approximation curve, a polynomial approximation curve, a power approximation curve, or an exponential approximation curve, and derive an estimated value.

The control unit 20 of the individual ECU 2 drives the illumination lamp 301 based on the derived estimated value (step S1092). The control unit 20 of the individual ECU 2 generates a drive signal based on the estimated value derived using the approximation formula, and outputs the drive signal to the relay control unit 24 connected to the illumination lamp 301, thereby driving the illumination lamp 301.

The control unit 20 of the individual ECU 2 determines whether or not output of all of the control signals from the integrated ECU 6 is complete (step S112). From among a plurality of control signals that are sequentially transmitted from the integrated ECU 6, for example, the control signal transmitted last is given a last flag indicating that the control signal is the last control signal. The control unit 20 of the individual ECU 2 can determine whether or not all of the control signals have been completely output from the integrated ECU 6, by obtaining the control signal to which the last flag was given.

If output of all of the control signals from the integrated ECU 6 is complete (step S112: YES), the control unit 20 of the individual ECU 2 ends a series of processing in this flow. If output of all of the control signals from the integrated ECU 6 is incomplete (step S112: NO), the control unit 20 of the individual ECU 2 performs loop processing in order to execute the processing of step S107 again.

### Second Embodiment

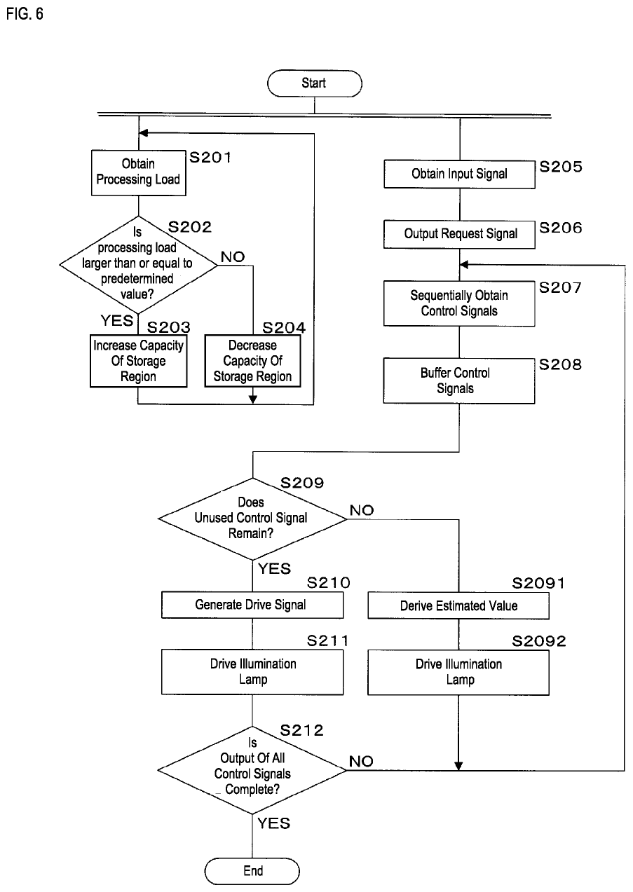

FIG. 6 is a flowchart illustrating an example of processing that is performed by the control unit 20 of an individual ECU 2 according to a second embodiment (a processing load of the integrated ECU 6). Similarly to the first embodiment, the control unit 20 of the individual ECU 2 constantly performs the following processing, for example, when the vehicle C is in an activated state (the ignition switch is on).

The control unit 20 of the individual ECU 2 obtains the processing load of the integrated ECU 6 (step S201). The control unit 20 of the individual ECU 2 routinely, periodically, or cyclically performs polling communication or the like with the integrated ECU 6 via the in-vehicle communication unit 23, and obtains information regarding the processing load such as the usage rate of the CPU of the control unit 60 of the integrated ECU 6.

The control unit 20 of the individual ECU 2 determines whether or not the processing load of the integrated ECU 6 is larger than or equal to a predetermined value (step S202). The storage unit 21 of the individual ECU 2 stores information regarding the predetermined value as a CPU usage rate of 85%. The control unit 20 of the individual ECU 2 determines whether or not the processing load of the integrated ECU 6 is larger than or equal to the predetermined value stored in the storage unit 21.

If the processing load is larger than or equal to the predetermined value (step S202: YES), the control unit 20 of the individual ECU 2 increases the capacity of the predetermined storage region (step S203). If the processing load is larger than or equal to the predetermined value, a delay in processing performed by the integrated ECU 6 is expected, and the control unit 20 of the individual ECU 2 increases the capacity of the predetermined storage region (buffer region), obtains control information from the integrated ECU 6, and increases the amount of control information that is to be buffered.

If the processing load is smaller than the predetermined value (step S202: NO), the control unit 20 of the individual ECU 2 decreases the capacity of the predetermined storage region (step S204). Determining that processing that is being performed by the integrated ECU 6 is in a stable state, the control unit 20 of the individual ECU 2 can secure a storage region of the individual ECU 2 to be used for other processing, by releasing a portion of the occupied buffer region to decrease the capacity.

After executing the processing of step S203 or S204, the control unit 20 of the individual ECU 2 performs loop processing in order to execute the processing of step S201 again. By performing, in this manner, the processing of steps S201 to S204 in a process in parallel with a different process of performing other processing, it is possible to continue to change (increase/decrease) the capacity of the predetermined storage region in accordance with the processing load of the integrated ECU 6, and, even when processing performed by the integrated ECU 6 is delayed, it is possible to deal with such a delay.

Similarly to the processing of steps S105 to S112 in the first embodiment, the control unit 20 of the individual ECU 2 performs the processing of steps S205 to S212.

### Third Embodiment

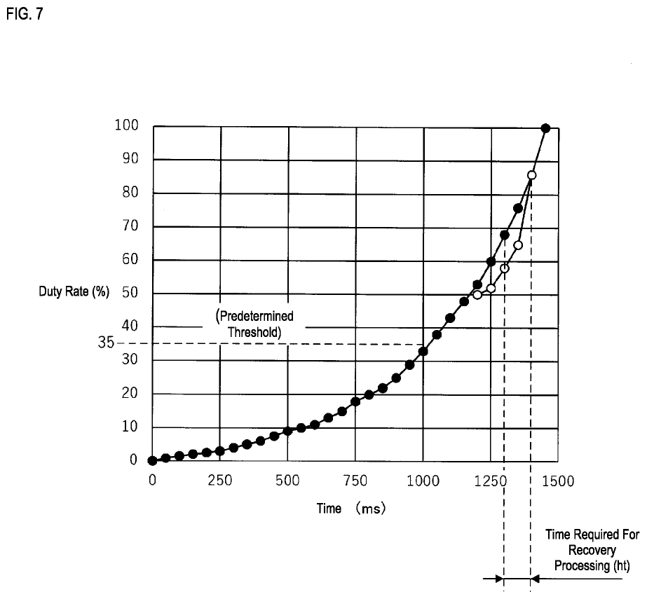

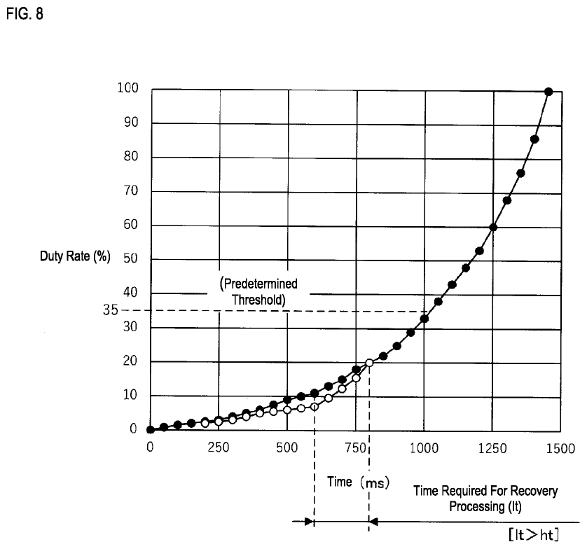

FIG. 7 is an explanatory diagram related to recovery processing (when a duty rate is high) according to a third embodiment (recovery processing). FIG. 8 is an explanatory diagram related to recovery processing (when a duty rate is low). In the illustrated figures of the present embodiment, similarly to the first embodiment, the horizontal axis indicates time points (lapsed times) in a predetermined cycle in which initiation of light emission is used as a base point, and the vertical axis indicates duty ratios each corresponding to a light amount (luminance value) of the illumination lamp 301.

The luminance values (duty ratios) indicated by the illustrated graph include luminance values related to curve information for control stored in the storage unit 61 of the integrated ECU 6, luminance values (estimated duty ratios) derived by the individual ECU 2 as estimated values, and luminance values that are used for recovery processing (recovery processing duty ratios). In the illustrated figures of the present embodiment, points indicated by black dots represent luminance values (duty ratios) included in the curve information for control (fade curve information) stored in the storage unit 61 of the integrated ECU 6. In the illustrated figures of the present embodiment, points indicated by blank dots represent luminance values (estimated duty ratios) derived by the individual ECU 2 as estimated values and luminance values (recovery processing duty ratios) that are used for recovery processing.

Similarly to the first embodiment, for example, when communication between the integrated ECU 6 and the individual ECU 2 has been disconnected, and all of the control signals buffered (stored) in the predetermined storage region (buffer region) have been used, the individual ECU 2 derives at least one estimated value based on previously used control signals (duty ratios). In addition to this, when communication with the integrated ECU 6 is resumed, the individual ECU 2 derives a duty ratio (recovery processing duty ratio) that is used for recovery processing, based on a duty ratio included in the first control signal obtained after communication is resumed, and a time period required for recovery processing corresponding to the duty ratio.

The time period required for recovery processing corresponding to the duty ratio is determined based on whether or not the duty ratio is higher than or equal to a predetermined threshold. The storage unit 21 of the individual ECU 2 stores a predetermined threshold for classifying duty ratios, in other words, for sorting duty ratios into high duty ratios and low duty ratios. The predetermined threshold is 35%, for example, and may be determined based on light emission properties such as the maximum light amount of the illumination lamp 301.

A time period required for recovery processing for a high duty ratio (high duty recovery time: ht) takes a smaller value (shorter time) than a time period required for recovery processing for a low duty ratio (low duty recovery time: lt) (ht<lt). That is to say, provided that the time period required for recovery processing for a high duty ratio (high duty recovery time: ht) has two cycles, for example, the time period required for recovery processing for a low duty ratio (low duty recovery time: lt) has four cycles, which is longer than the high duty recovery time. When the duty ratio is low (dark) and changes rapidly, a passenger of the vehicle C is likely to feel that something is amiss, but it is possible to suppress the sensation that something is amiss by setting, to a relatively long time period, the time period required for recovery processing when the duty ratio is lower than the predetermined threshold.

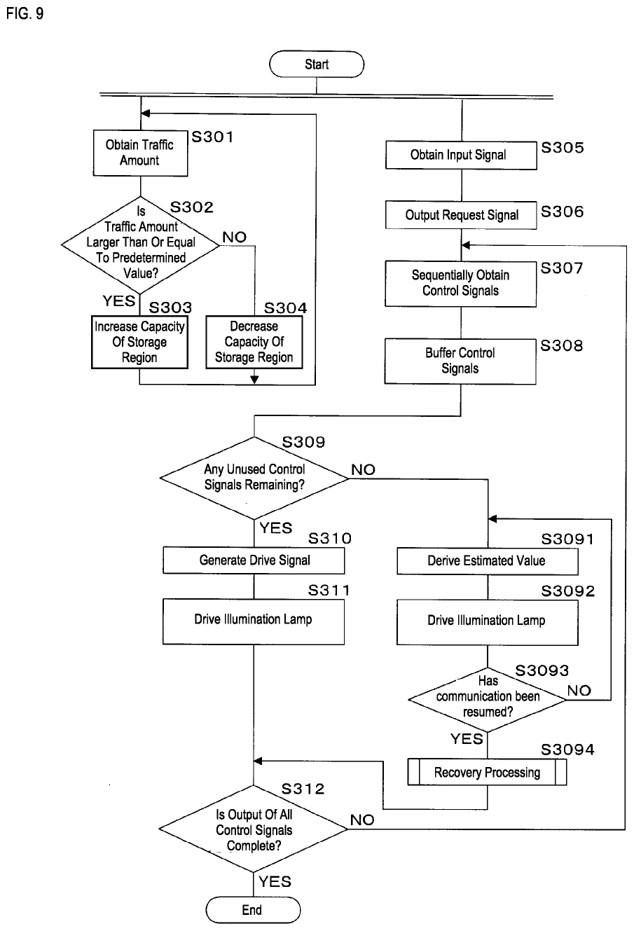

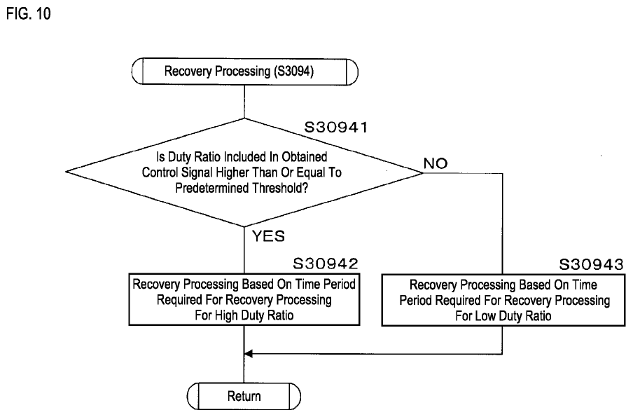

FIG. 9 is a flowchart illustrating an example of processing that is performed by the control unit 20 of the individual ECU 2. FIG. 10 is a flowchart illustrating an example of recovery processing that is performed by the control unit of the individual ECU 2. Similarly to the first embodiment, for example, when the vehicle C is in an activated state (the ignition switch is on), the control unit 20 of the individual ECU 2 constantly performs the following processing. Similarly to the processing of steps S101 to S111 and S1092 in the first embodiment, the control unit 20 of the individual ECU 2 performs the processing of steps S301 to S311 and S3092.

The control unit 20 of the individual ECU 2 determines whether or not communication with the integrated ECU 6 has resumed (step S3093). When obtaining of control signals output from the integrated ECU 6 is resumed, the control unit 20 of the individual ECU 2 determines that communication with the integrated ECU 6 has been resumed. A factor for disconnection of communication with the integrated ECU 6 is, for example, that congestion in the onboard network 4 results in a timeout in communication between the integrated ECU 6 and the individual ECU 2, or that an increase in the processing load of the integrated ECU 6 prevents the integrated ECU 6 from generating and outputting control signals. As described above, the control unit 20 of the individual ECU 2 waits for control signals that are output from the integrated ECU 6, and, when the traffic amount of the onboard network 4 or the processing load of the integrated ECU 6 decreases, the control unit 20 of the individual ECU 2 resumes obtaining control signals output from the integrated ECU 6.

If communication with the integrated ECU 6 has not resumed (step S3093: NO), the control unit 20 of the individual ECU 2 performs loop processing in order to execute the processing of step S3091 again. Even if communication with the integrated ECU 6 has not resumed, the control unit 20 of the individual ECU 2 can execute the processing of step S3091 again, derive an estimated value using the approximation formula generated based on control signals used in the past, and continue to drive the illumination lamp 301 based on the estimated value.

If communication with the integrated ECU 6 has been resumed (step S3093: YES), the control unit 20 of the individual ECU 2 performs recovery processing (step S3094). FIG. 10 shows detailed recovery processing (step S3094).

The control unit 20 of the individual ECU 2 determines whether or not the duty ratio included in an obtained control signal is higher than or equal to a predetermined threshold (step S30941). The storage unit 21 of the individual ECU 2 stores a predetermined threshold for classifying duty ratios, in other words, for sorting duty ratios into high duty ratios and low duty ratios. The predetermined threshold may be set to 35%, or may be determined based on the light emission properties such as the maximum light amount and the like of the illumination lamp 301.

If the duty ratio is higher than or equal to the predetermined threshold (step S30941: YES), the control unit 20 of the individual ECU 2 performs recovery processing based on the time period required for recovery processing for a high duty ratio (step S30942). If the duty ratio is lower than the predetermined threshold (step S30941: NO), the control unit 20 of the individual ECU 2 performs recovery processing based on the time period required for recovery processing for a low duty ratio (step S30943). Regardless of whether the duty ratio is high or low, the control unit 20 of the individual ECU 2 derives a duty ratio (recovery processing duty ratio) that is used for recovery processing, based on the last derived estimated value, a duty ratio included in a control signal first obtained after communication with the integrated ECU 6 has resumed, and a time period required for recovery processing corresponding to the duty ratio.

If the duty ratio is higher than or equal to a predetermined threshold, the control unit 20 of the individual ECU 2 performs recovery processing based on the time period required for recovery processing for a high duty ratio, and, if the duty ratio is smaller than the predetermined threshold, the control unit 20 of the individual ECU 2 performs recovery processing based on the time period required for recovery processing for a low duty ratio. The time period required for recovery processing for a high duty ratio (high duty recovery time: ht) takes a smaller value (shorter time) than the time period required for recovery processing for a low duty ratio (low duty recovery time: lt) (ht<lt). Therefore, when the duty ratio is low (dark) and changes rapidly, a passenger of the vehicle C is likely to feel that something is amiss, but it is possible to suppress the sensation that something is amiss by setting, to a longer time period, the time period required for recovery processing when the duty ratio is lower than the predetermined threshold. In addition, even when the duty ratio is high (bright) and rapidly changes, a passenger of the vehicle C is unlikely to feel that something is amiss, and thus, by setting, to a shorter time period, the time period required for recovery processing when the duty ratio is higher than or equal to the predetermined threshold, it is possible to restore control performed by the integrated ECU 6 that has resumed communication, at an early stage.

The control unit 20 of the individual ECU 2 derives a plurality of recovery processing duty ratios, in accordance with the time period required for recovery processing corresponding to a duty ratio. These recovery processing duty ratios are used in a predetermined cycle in a continuous manner. The control unit 20 of the individual ECU 2 generates a plurality of recovery processing duty ratios such that the difference (Δduty ratio) between a recovery processing duty ratio and a duty ratio included in a control signal obtained after communication with the integrated ECU 6 has resumed decreases in a stepwise manner. Accordingly, it is possible to derive a plurality of recovery processing duty ratios that realize a suitable change rate corresponding to a time period required for recovery processing, and smoothly perform recovery processing by sequentially using these recovery processing duty ratios.

The embodiments disclosed herein are examples in all respects and should not be interpreted as limiting in any manner. The scope of the present disclosure is defined not by the foregoing meanings, but by the scope of the claims, and indented to include all modifications that are equivalent to or within the scope of the claims.

1. A first onboard ECU that is communicably connected to an onboard apparatus mounted in a vehicle and a second onboard ECU that outputs information regarding control of the onboard apparatus, the first onboard ECU comprising
a control unit configured to perform processing related to driving of the onboard apparatus,
wherein the control unit sequentially obtains a plurality of pieces of information regarding control of the onboard apparatus that are output from the second onboard ECU,
buffers, in a predetermined storage region, the sequentially obtained pieces of information, and
performs processing related to driving of the onboard apparatus based on the information buffered in the predetermined storage region, and
the plurality of pieces of information buffered in the predetermined storage region include information to be used later than information that is used at the present point in time.

2. The first onboard ECU according to claim 1,
wherein the onboard apparatus is an illumination lamp,
the second onboard ECU outputs information regarding control of the illumination lamp generated based on predetermined curve information for control,
information that is output from the second onboard ECU includes a duty ratio for controlling a light amount of the illumination lamp, and
the control unit performs processing related to driving of the illumination lamp based on the duty ratio obtained from the second onboard ECU.

3. The first onboard ECU according to claim 1,
wherein the control unit changes a capacity of the predetermined storage region that is used for buffering the plurality of pieces of information, in accordance with a state of communication with the second onboard ECU.

4. The first onboard ECU according to claim 1,
wherein the control unit changes the capacity of the predetermined storage region that is used for buffering the plurality of pieces of information, in accordance with a processing load of the second onboard ECU.

5. The first onboard ECU according to claim 1,
wherein, when all of the pieces of information buffered in the predetermined storage region have been used as a result of communication with the second onboard ECU being disconnected, the control unit derives an estimated value based on a plurality of previously used pieces of information, and
performs processing related to driving of the onboard apparatus using the estimated value.

6. The first onboard ECU according to claim 1,
wherein information that is output from the second onboard ECU includes a duty ratio for controlling a light amount of the onboard apparatus that is an illumination lamp,
the control unit performs, when disconnected communication with the second onboard ECU is resumed, recovery processing that is based on information obtained from the second onboard ECU after the resumption of communication, and
a time period required for recovery processing when the duty ratio is higher than or equal to a predetermined threshold is shorter than a time period required for recovery processing when the duty ratio is lower than the predetermined threshold.

7. The first onboard ECU according to claim 6,
wherein, when performing the recovery processing, the control unit derives a recovery processing duty ratio using a derived estimated value, a duty ratio included in information obtained after communication with the second onboard ECU has been resumed, and the time period required for recovery processing, and
performs processing related to driving of the onboard apparatus based on the derived recovery processing duty ratio.

8. A program for causing a computer that is communicably connected to an onboard apparatus mounted in a vehicle and a second onboard ECU that outputs information regarding control of the onboard apparatus, to perform processing for:
sequentially obtaining a plurality of pieces of information regarding control of the onboard apparatus that are output from the second onboard ECU;
buffering, in a predetermined storage region, the sequentially obtained pieces of information; and
performing processing related to driving of the onboard apparatus based on the information buffered in the predetermined storage region,
wherein the plurality of pieces of information buffered in the predetermined storage region include information to be used later than information that is used at the present point in time.

9. An information processing method for causing a computer that is communicably connected to an onboard apparatus mounted in a vehicle and a second onboard ECU that outputs information regarding control of the onboard apparatus, to perform processing for:
sequentially obtaining a plurality of pieces of information regarding control of the onboard apparatus that are output from the second onboard ECU;
buffering, in a predetermined storage region, the sequentially obtained pieces of information; and
performing processing related to driving of the onboard apparatus based on the information buffered in the predetermined storage region,
wherein the plurality of pieces of information buffered in the predetermined storage region include information to be used later than information that is used at the present point in time.

10. An onboard system that includes a first onboard ECU that is directly connected to an onboard apparatus and a second onboard ECU that is communicably connected to the first onboard ECU,
wherein the second onboard ECU generates a plurality of control signals for controlling the onboard apparatus based on predetermined curve information for control, and
sequentially outputs the generated control signals to the first onboard ECU,
the first onboard ECU sequentially obtains the control signals output from the second onboard ECU,
buffers, in a predetermined storage region, the sequentially obtained control signals,
generates a drive signal for driving the onboard apparatus based on information buffered in the predetermined storage region, and
sequentially outputs the generated drive signals to the onboard apparatus, and
the plurality of control signals buffered in the predetermined storage region include a control signal to be used later than a control signal that is used at the present point in time.

11. The first onboard ECU according to claim 2,
wherein the control unit changes a capacity of the predetermined storage region that is used for buffering the plurality of pieces of information, in accordance with a state of communication with the second onboard ECU.

12. The first onboard ECU according claim 2,
wherein the control unit changes the capacity of the predetermined storage region that is used for buffering the plurality of pieces of information, in accordance with a processing load of the second onboard ECU.

13. The first onboard ECU according to claim 3,
wherein the control unit changes the capacity of the predetermined storage region that is used for buffering the plurality of pieces of information, in accordance with a processing load of the second onboard ECU.

14. The first onboard ECU according to claim 2,
wherein, when all of the pieces of information buffered in the predetermined storage region have been used as a result of communication with the second onboard ECU being disconnected, the control unit derives an estimated value based on a plurality of previously used pieces of information, and
performs processing related to driving of the onboard apparatus using the estimated value.

15. The first onboard ECU according to claim 3,
wherein, when all of the pieces of information buffered in the predetermined storage region have been used as a result of communication with the second onboard ECU being disconnected, the control unit derives an estimated value based on a plurality of previously used pieces of information, and
performs processing related to driving of the onboard apparatus using the estimated value.

16. The first onboard ECU according claim 4,
wherein, when all of the pieces of information buffered in the predetermined storage region have been used as a result of communication with the second onboard ECU being disconnected, the control unit derives an estimated value based on a plurality of previously used pieces of information, and
performs processing related to driving of the onboard apparatus using the estimated value.

17. The first onboard ECU according to claim 2,
wherein information that is output from the second onboard ECU includes a duty ratio for controlling a light amount of the onboard apparatus that is an illumination lamp,
the control unit performs, when disconnected communication with the second onboard ECU is resumed, recovery processing that is based on information obtained from the second onboard ECU after the resumption of communication, and
a time period required for recovery processing when the duty ratio is higher than or equal to a predetermined threshold is shorter than a time period required for recovery processing when the duty ratio is lower than the predetermined threshold.

18. The first onboard ECU according to claim 3,
wherein information that is output from the second onboard ECU includes a duty ratio for controlling a light amount of the onboard apparatus that is an illumination lamp,
the control unit performs, when disconnected communication with the second onboard ECU is resumed, recovery processing that is based on information obtained from the second onboard ECU after the resumption of communication, and
a time period required for recovery processing when the duty ratio is higher than or equal to a predetermined threshold is shorter than a time period required for recovery processing when the duty ratio is lower than the predetermined threshold.

19. The first onboard ECU according to claim 4,
wherein information that is output from the second onboard ECU includes a duty ratio for controlling a light amount of the onboard apparatus that is an illumination lamp,
the control unit performs, when disconnected communication with the second onboard ECU is resumed, recovery processing that is based on information obtained from the second onboard ECU after the resumption of communication, and
a time period required for recovery processing when the duty ratio is higher than or equal to a predetermined threshold is shorter than a time period required for recovery processing when the duty ratio is lower than the predetermined threshold.

20. The first onboard ECU according to claim 5,
wherein information that is output from the second onboard ECU includes a duty ratio for controlling a light amount of the onboard apparatus that is an illumination lamp,
the control unit performs, when disconnected communication with the second onboard ECU is resumed, recovery processing that is based on information obtained from the second onboard ECU after the resumption of communication, and
a time period required for recovery processing when the duty ratio is higher than or equal to a predetermined threshold is shorter than a time period required for recovery processing when the duty ratio is lower than the predetermined threshold.
